(19) United States
(12) Patent Application Publication
(10) Pub. No.: US 2024/0202831 A1
(43) Pub. Date: Jun. 20, 2024

(54) TERMINAL DEVICE, INFORMATION PROCESSING METHOD, PROGRAM, RELAY SERVER, AND INSURANCE BUSINESS SERVER

(71) Applicant: Sony Group Corporation, Tokyo (JP)

(72) Inventors: Masashi MORI, Tokyo (JP); Kazumasa MIYAZAKI, Tokyo (JP); Yasuhiro HORI, Kanagawa (JP)

(73) Assignee: Sony Group Corporation, Tokyo (JP)

(21) Appl. No.: 18/287,127

(22) PCT Filed: Jan. 4, 2022
(86) PCT No.: PCT/JP2022/000052

§ 371 Date: Oct. 16, 2023

(30) Foreign Application Priority Data
May 20, 2021 (JP) 2021-084994

(51) Int. Cl. G06Q 40/08

(52) U.S. Cl. CPC G06Q 40/08

(57) ABSTRACT

A terminal device 20 collects sensing information to be used for selection of an insurance product, and transmits the sensing information to a relay server 30. The relay server 30 anonymizes sensing information acquired from the terminal device 20, and provides the sensing information to an insurance business server 40. The insurance business server 40 generates insurance proposal information indicating an insurance product selected on the basis of the anonymized sensing information, and transmits the insurance proposal information to the relay server 30. The relay server 30 transfers the insurance proposal information transmitted from the insurance business server 40, to the terminal device 20 that is a providing source of the sensing information. A user can easily receive a proposal for an insurance product optimal for the user's activity or the like from one or plurality of insurance companies, without providing personal information or the like. Furthermore, the insurance company can propose a detailed insurance product according to the user.

### TECHNICAL FIELD

The present technology relates to a terminal device, an information processing method, a program, a relay server, and an insurance business server, and makes it possible to receive a proposal for an optimal insurance product on the basis of information that does not allow identification of an individual.

### BACKGROUND ART

Conventionally, in order for a user to conclude a contract for an insurance product, it has been necessary to examine an insurance product provided by each insurance company and perform selection, comparison, and the like, which requires effort and time. For this reason, Patent Document 1 discloses a computer system that proposes, to a client, a product or a service that meets a client's potential or original needs.

### CITATION LIST

### Patent Document

Patent Document 1: Japanese Patent Application Laid-Open No. 2019-139782

### SUMMARY OF THE INVENTION

### Problems to be Solved by the Invention

Meanwhile, in the computer system of Patent Document 1, a risk concerning a client is identified on the basis of personal information on the client and an answer to a question to the client, and at least one commodity or service to be proposed to the client is determined on the basis of the risk. For this reason, the proposal of the insurance product cannot be received unless the personal information is provided.

Therefore, an object of the present technology is to provide a terminal device, an information processing method, a program, a relay server, and an insurance business server that can receive a proposal of an optimal insurance product on the basis of information that does not allow identification of an individual.

### Solutions to Problems

A first aspect of the present technology is
a terminal device including:
a communication unit configured to communicate with a relay server and an insurance business server, the relay server being configured to anonymize sensing information to be used for selection of an insurance product and provide the sensing information to the insurance business server, and the insurance business server being configured to transmit insurance proposal information indicating an insurance product selected on the basis of the anonymized sensing information;
a user interface unit configured to present, to a user, the insurance proposal information informed from the insurance business server via the relay server; and
a control unit configured to control operations of the communication unit and the user interface unit.

In the present technology, the communication unit communicates with: the relay server configured to anonymize sensing information to be used for selection of an insurance product and provide the sensing information to the insurance business server; and the insurance business server configured to transmit insurance proposal information indicating an insurance product selected on the basis of the anonymized sensing information. The information collection unit configured to collect sensing information acquires information regarding physical activity of the user as the sensing information. The user interface unit presents, to the user, the insurance proposal information informed from the insurance business server via the relay server.

The control unit controls operations of the communication unit and the user interface unit, and transmits sensing information of a user verified by user authentication processing to the relay server without including personal information. Furthermore, the control unit controls the communication unit to communicate with the insurance business server without via the relay server, in response to a user operation on the insurance proposal information presented by the user interface unit.

In a case where position information is collected by the information collection unit, the control unit uses a type of a facility identified by the position information as the sensing information. Furthermore, the control unit transmits the sensing information to the relay server when the sensing information for a predetermined period is collected.

Moreover, after conclusion of a contract of an insurance product proposed by the insurance proposal information, the control unit provides sensing information to the insurance business server without via the relay server, and the control unit presents, on the user interface unit, follow-up information that is provided from the insurance business server after conclusion of the contract and is related to an insurance product for which the contract is concluded.

A second aspect of the present technology is
an information processing method including:
communicating with a relay server and an insurance business server by using a communication unit, the relay server being configured to anonymize sensing information to be used for selection of an insurance product and transfer the sensing information to the insurance business server, and the insurance business server being configured to transmit insurance proposal information indicating an insurance product selected on the basis of the anonymized sensing information;
informing, to a user, the insurance proposal information informed from the insurance business server via the relay server, by using a user interface unit; and
controlling operations of the communication unit and the user interface unit by using a control unit.

A third aspect of the present technology is
a program for causing a computer to execute purchase of an insurance product,
the program causing the computer to execute:
a procedure of transmitting sensing information to a relay server configured to anonymize the sensing information to be used for selection of the insurance product and transfer the sensing information to an insurance business server;
a procedure of acquiring insurance proposal information transmitted via the relay server from the insurance business server configured to transmit the insurance proposal information indicating an insurance product selected on the basis of the anonymized sensing information;
a procedure of informing, to a user, the insurance proposal information informed from the insurance business server via the relay server, by using a user interface unit; and
a procedure of performing an insurance contract between with the insurance business server in response to a user operation on the basis of the insurance proposal information.

Note that the program of the present technology is, for example, a program that can be provided to a general-purpose computer capable of executing various programs or codes by a storage medium provided in a computer-readable format, a communication medium, for example, a storage medium such as an optical disk, a magnetic disk, a semiconductor memory, or the like, or a communication medium such as a network or the like. By providing such program in the computer-readable form, processing according to the program is implemented on the computer.

A fourth aspect of the present technology is a relay server including:
a relay control unit configured to anonymize sensing information supplied from a terminal device that collects sensing information to be used for selection of an insurance product, provide the sensing information to one or plurality of insurance business servers, and transfer insurance proposal information informed from the insurance business server to a terminal device that is a providing source of the sensing information, in response to provision of the anonymized sensing information to the insurance business server.

A fifth aspect of the present technology is an insurance business server including:
an insurance business processing unit configured to perform processing of generating insurance proposal information on the basis of sensing information provided from a relay server, and transmitting the insurance proposal information to the relay server, the relay server being configured to anonymize sensing information to be used for selection of an insurance product, and the insurance business processing unit being configured to perform insurance conclusion processing between with a terminal device in which a contract request is made on the basis of the insurance proposal information.

### BRIEF DESCRIPTION OF DRAWINGS

FIG. 1 is a diagram illustrating a configuration of an insurance system.

FIG. 2 is a diagram illustrating a configuration of a terminal device.

FIG. 3 is a flowchart illustrating an insurance-related operation of the terminal device.

FIG. 4 is a flowchart illustrating an operation of a relay server.

FIG. 5 is a flowchart illustrating an operation of an insurance business server.

FIG. 6 is a sequence diagram illustrating an operation example of the insurance system.

FIG. 7 is a view illustrating an operation display example (part 1) of the terminal device.

FIG. 8 is a view illustrating an operation display example (part 1) of the insurance business server.

FIG. 9 is a view illustrating an operation display example (part 2) of the terminal device.

FIG. 10 is a view illustrating an operation display example (part 2) of the insurance business server.

FIG. 11 is a view illustrating an operation display example (part 3) of the terminal device.

### MODE FOR CARRYING OUT THE INVENTION

Hereinafter, a mode for carrying out the present technology is described. Note that, the description will be given in the following order.
1. Configuration of insurance system
2. Operation of insurance system
   2-1. Operation of terminal device
   2-2. Operation of relay server
   2-3. Operation of insurance business server
   2-4. Operation example of insurance system
   2-5. Other operations of the insurance system

### <1. Configuration of Insurance System>

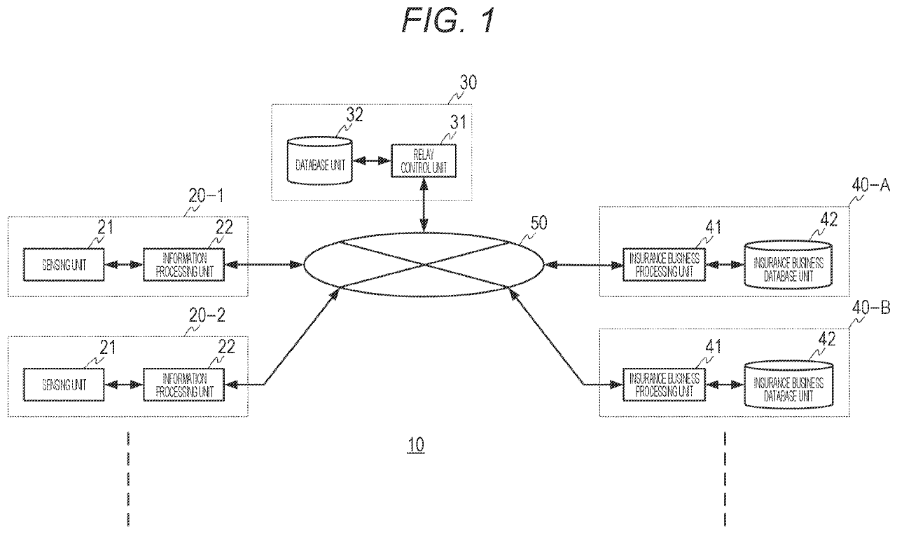

FIG. 1 illustrates a configuration of an insurance system of the present technology. In an insurance system 10, terminal devices 20-1, 20-2, . . . for every user, a relay server 30, and insurance business servers 40-A, 40-B, . . . for every insurance company are connected via a network 50.

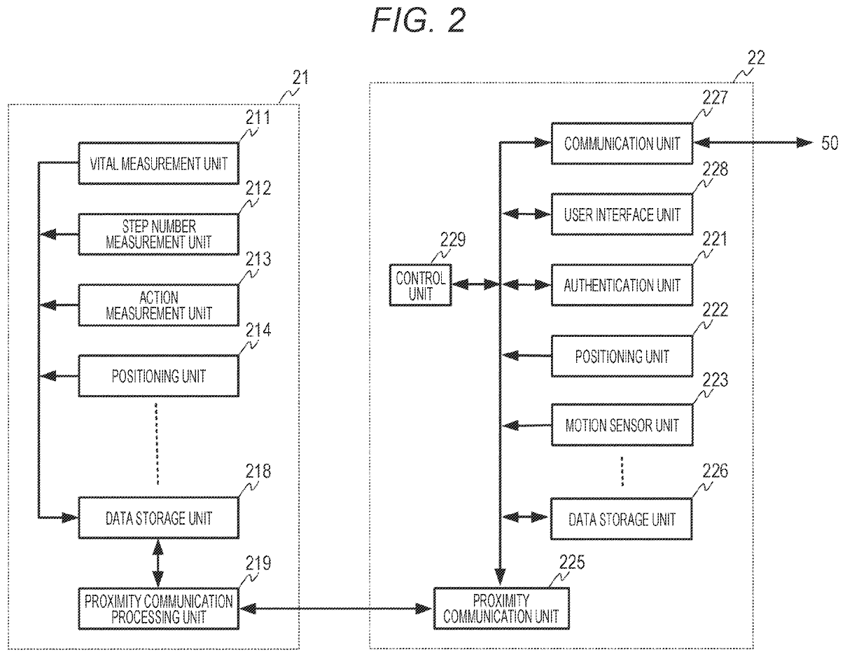

The terminal device 20-1 has a sensing unit 21 and an information processing unit 22. FIG. 2 illustrates a configuration of a terminal device. The sensing unit 21 collects sensing information to be used for selection of an insurance product. The sensing information to be used for selection of the insurance product is, for example, information to be used for calculation of an insurance premium corresponding to a compensation content of the insurance product. For example, in selection of an insurance product for the purpose of health promotion, vital information such as a heart rate, a blood pressure, a respiratory rate, oxygen saturation, a body temperature, and the like, and information indicating what kind of activity has been performed to what extent, how much position movement has occurred, and the like are used as the sensing information. The sensing unit 21 has, for example, a vital measurement unit 211, a step number measurement unit 212, an action measurement unit 213, a positioning unit 214, a data storage unit 218, and a proximity communication processing unit 219, in order to collect the sensing information to be used for selection of an insurance product.

The vital measurement unit 211 measures vital information (for example, at least any of a heart rate, a blood pressure, a respiratory rate, oxygen saturation, a body temperature, and the like) of a user wearing the sensing unit 21, and causes the data storage unit 218 to hold the vital information.

The step number measurement unit 212 measures the number of steps of the user wearing the sensing unit 21, and causes the data storage unit 218 to hold a step number measurement result.

The action measurement unit 213 measures what kind of action (for example, walking, running, sports such as tennis and golf, work performed in daily life, and the like) being taken by the user wearing the sensing unit 21, and causes the data storage unit 218 to hold an action measurement result.

The positioning unit 214 receives a positioning signal transmitted from a satellite or the like, a beacon signal from an access point, or the like to measure a position of the sensing unit 21, and causes the data storage unit 218 to hold a position measurement result.

The data storage unit 218 holds sensing information such as the vital information, the step number measurement result, the action measurement result, and the position measurement result. Furthermore, the sensing information held in the data storage unit 218 is read by the proximity communication processing unit 219.

The proximity communication processing unit 219 performs wireless communication between with the information processing unit 22 by using short-range wireless communication technology (for example, Bluetooth (trademark), near field communication (NFC), or the like). The proximity communication processing unit 219 reads, from the data storage unit 218, sensing information of a user of the terminal device 20-1 verified to be a user registered in advance on the basis of an authentication result of the user informed from the information processing unit 22, and outputs the sensing information to the information processing unit 22.

The information processing unit 22 performs management of sensing information, presentation of insurance proposal information transmitted from an insurance company, contract conclusion processing of a proposed insurance product, and the like. The information processing unit 22 has, for example, an authentication unit 221, a positioning unit 222, a motion sensor unit 223, a proximity communication unit 225, a data storage unit 226, a communication unit 227, a user interface unit 228, and a control unit 229.

The authentication unit 221 performs authentication processing for verifying whether the user of the terminal device 20-1 is a user registered in advance. The authentication unit 221 performs authentication processing by using: user's knowledge information (for example, an ID, a password, an answer registered in advance for a question, an individual identification number, and the like): possession information (for example, a one-time password, an encryption table, or the like); and user's biometric information (for example, face, fingerprint information, iris information, vein information, and the like), and outputs an authentication result to the control unit 229. Note that the authentication unit 221 may use physical characteristics, action characteristics, or the like of a human.

The positioning unit 222 receives a positioning signal transmitted from a satellite or the like, a beacon signal from an access point, or the like to perform position measurement, and causes the data storage unit 226 to hold a position measurement result indicating a position of the information processing unit 22 or a change in position.

The motion sensor unit 223 is configured using an inertial measurement unit (IMU), an acceleration sensor, or the like. The motion sensor unit 223 detects a motion (for example, speed, acceleration, or the like) of the information processing unit 22, and causes the data storage unit 226 to hold a motion detection result.

The proximity communication unit 225 performs wireless communication with between the sensing unit 21 by using a short-range wireless communication technology (for example, Bluetooth (trademark), near field communication (NFC), or the like). In a case where the user is verified as a user registered in advance on the basis of the authentication result of the user in the authentication unit 221, the proximity communication unit 225 collects sensing information of the verified user from the sensing unit 21.

The data storage unit 226 holds the sensing information collected from the sensing unit 21, the position measurement result obtained by the positioning unit 222, and the motion detection result obtained by the motion sensor unit 223.

The communication unit 227 communicates with the relay server 30 that anonymizes sensing information to be used for selection of an insurance product and provides the sensing information to the insurance business server, via the network 50. The anonymization is, for example, removing personal information directly related to identification of an individual from data regarding a specific individual. The communication unit 227 communicates with the insurance business server 40-A or the like that generates and transmits insurance proposal information on the basis of the anonymized sensing information, via the network 50. Note that the insurance proposal information indicates a product content of a proposed insurance product and a contact (for example, a URL, an e-mail address, or the like) for making a contract of the proposed insurance product, as the proposed insurance product for proposing, to the user, the insurance product selected on the basis of the anonymized sensing information.

The user interface unit 228 presents various types of information to the user and receives a user operation. For example, in the user interface unit 228, a display element and a touch panel on a display surface of the display element are provided to form a graphical user interface (GUI). The user interface unit 228 presents the insurance proposal information transmitted from the insurance business server 40-A or the like, to the user via the relay server 30. Furthermore, the user interface unit 228 outputs an operation signal corresponding to a user operation, to the control unit 229.

The control unit 229 controls an operation of each unit of the information processing unit 22. Furthermore, the control unit 229 controls the proximity communication unit 225 and the communication unit 227 on the basis of the authentication result of the authentication unit 221, to collect sensing information to be used for selection of an insurance product from the sensing unit 21 and transmit the collected sensing information to the relay server 30. Furthermore, the control unit 229 collects the sensing information when an authenticated state is continued, and stops the collection of sensing information or discards the collected sensing information so as not to collect sensing information of a different user or the like when the authenticated state is no longer continued. When sensing information for a predetermined period (for example, on a predetermined time basis, a day basis, a week basis, a month basis, or the like) is collected, the control unit 229 transmits the sensing information to the relay server 30 without including personal information of the user. Note that the control unit 229 may transmit the sensing information to the relay server 30 as needed. Moreover, in response to presentation of the insurance proposal information transmitted from the insurance business server 40-A or the like by using the user interface unit 228, or a user operation on the presented insurance proposal information, the control unit 229 controls the communication unit 227 to communicate with the insurance business server 40 without via the relay server 30, and performs processing of a contract or the like of an insurance product indicated by the insurance proposal information. Furthermore, the control unit performs processing of providing the sensing information to the insurance business server 40 without via the relay server 30 after conclusion of the contract of the insurance product proposed by the insurance proposal information, and performs processing of presenting, on the user interface unit 228, follow-up information that is provided from the insurance business server 40 after conclusion of the contract and is related to the insurance product for which the contract is concluded. Note that the follow-up information will be described later.

The configuration of the terminal device 20-1 is not limited to the configuration in which the sensing unit 21 and the information processing unit 22 acquire sensing information as illustrated in FIG. 2. For example, the terminal device 20-1 may have a configuration in which the configuration of the sensing unit 21 is provided in the information processing unit 22, or the sensing information is acquired only by the sensing unit 21. Furthermore, the terminal devices 20-2, . . . may be configured similarly to the terminal device 20-1, and may have a configuration in which a part of the terminal device 20-1 is omitted or a configuration in which a functional block not illustrated in the terminal device 20-1 is added.

Returning to FIG. 1, the relay server 30 has a relay control unit 31 and a database unit 32. The relay control unit 31 performs processing of anonymizing sensing information acquired from the information processing unit 22 of each of the terminal devices 20-1, 20-2, . . . (hereinafter, a terminal device that collects sensing information and transmits the sensing information to the relay server 30 will be described as a terminal device 20), and transmitting the sensing information to the insurance business server 40-A or the like. Furthermore, in anonymization of sensing information, the relay control unit 31 replaces, for example, identification information indicating a terminal device having provided sensing information with relay identification information. Moreover, in response to provision of the anonymized sensing information to the insurance business server 40-A or the like, the relay control unit 31 transfers insurance proposal information transmitted from the insurance business server 40-A or the like to a providing source of the sensing information. In the transfer of the insurance proposal information, the relay control unit 31 returns the relay identification information used in the transmission of the insurance proposal information to the identification information, and transfers the insurance proposal information to the terminal device 20 that is the providing source of the sensing information.

The database unit 32 stores information indicating a correspondence relationship between the identification information of the terminal device that is the providing source of the sensing information and the relay identification information used when the anonymized sensing information is provided to the insurance business server 40-A or the like. Furthermore, the database unit 32 may hold sensing information acquired from the terminal device 20. In this way, by holding the sensing information, for example, the information processing unit 22 of the terminal device 20 can anonymize the sensing information for a period requested from the insurance business server 40-A or the like and provide the sensing information from the relay server 30 to the insurance business server 40-A or the like, without holding the sensing information for a long period of time.

The insurance business server 40-A has an insurance business processing unit 41 and an insurance business database unit 42.

The insurance business processing unit 41 proposes an insurance product, processes a contract, transmits follow-up information after conclusion of the contract, and the like. For example, the insurance business processing unit 41 performs processing of generating insurance proposal information on the basis of anonymized sensing information acquired from the relay server 30 and transmitting the insurance proposal information to the relay server 30, and communicates with the terminal device 20 without via the relay server 30 to perform insurance contract processing when a contract request for an insurance product indicated by the insurance proposal information is transmitted from the terminal device 20 of the user. Furthermore, the insurance business processing unit 41 acquires, from the terminal device 20 without via the relay server 30, sensing information to be used by an insured person (a user who has concluded the contract) after conclusion of the contract of the insurance product. The insurance business processing unit 41 generates follow-up information based on acquired non-anonymized sensing information, or based on the non-anonymized sensing information and the already acquired anonymized sensing information, and transmits the follow-up information to the terminal device 20. The follow-up information is information that is generated in association with an insurance product for which a contract is made in an insurance company on the basis of sensing information provided after conclusion of the contract or before and after conclusion of the contract, and is information to be informed to the insured person. For example, the insurance business processing unit 41 discriminates a risk of the insured person on the basis of the sensing information, and generates, as follow-up information, incentive information indicating a discount of an insurance premium, provision of various products, impartation of points that can be used for purchase of products, impartation of a product discount coupon, or the like, in a case where the risk of the insured person is lower than an assumed risk range. Furthermore, in a case where the risk of the insured person is higher than the assumed risk range, the insurance business processing unit 41 generates, as the follow-up information, disadvantageous notice information indicating that a disadvantage occurs such as an increase in insurance premium or inability to renew the insurance.

The insurance business database unit 42 stores information regarding an insurance product that can be proposed, insurance contract information (for example, personal information of an insured person, information regarding an insurance product for which a contract is concluded, and the like), sensing information of the insured person (for example, sensing information before and after conclusion of the contract), and the like.

Note that the insurance business servers 40-B, . . . may be configured similarly to the insurance business server 40-A, or may have a configuration in which a functional block not illustrated in the insurance business server 40-A is provided. (hereinafter, an insurance business server that generates insurance proposal information on the basis of the sensing information and transmits the insurance proposal information to the relay server 30 will be described as an insurance business server 40).

### <2. Operation of Insurance System>

When used by a user verified in the authentication processing, the terminal device 20 of the insurance system 10 collects sensing information to be used for selection of an insurance product and transmits the sensing information to the relay server 30 via the network 50.

The relay server 30 anonymizes sensing information acquired from the terminal device 20, and provides the sensing information to the insurance business server 40. For example, the relay server 30 performs anonymization such that a providing source of the sensing information is not known by the insurance business server 40, and provides the sensing information to the insurance business server 40.

The insurance business server 40 selects an optimal proposed insurance product on the basis of the anonymized sensing information provided from the relay server 30, generates insurance proposal information regarding the selected insurance product, and transmits the insurance proposal information to the relay server 30.

In response to provision of the anonymized sensing information to the insurance business server 40, the relay control unit 31 transfers the insurance proposal information transmitted from the insurance business server 40, to the terminal device 20 that is the providing source of the sensing information.

As described above, the insurance system 10 proposes an insurance product suitable for the user via the relay server 30 without allowing the insurance company to know to which user the sensing information belongs.

Furthermore, at a time of making a contract of the proposed insurance product, communication is performed between the terminal device 20 and the insurance business server 40 without via the relay server 30, and insurance contract processing is performed. Moreover, after conclusion of the insurance contract, sensing information is provided from the terminal device 20 to the insurance business server 40 without via the relay server 30. Moreover, the insurance business server 40 performs follow-up processing on the basis of the provided sensing information.

### <2-1. Operation of Terminal Device>

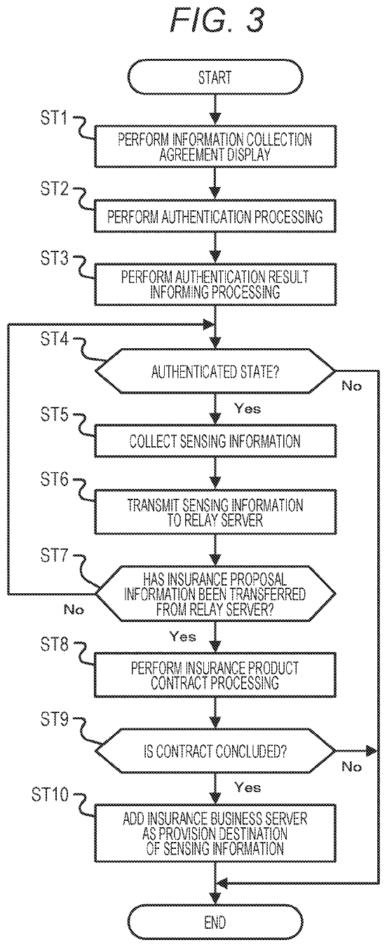

FIG. 3 is a flowchart illustrating an insurance-related operation of the terminal device. In step ST1, the terminal device performs information collection agreement display. The information processing unit 22 of the terminal device 20 performs display indicating that sensing information is collected and anonymized to be provided to an insurance company, for example, by using the user interface unit 228. When a user operation for agreeing to the provision of the sensing information is performed, the information processing unit 22 of the terminal device 20 proceeds to step ST2. Note that, if the user operation agreeing to the provision of the sensing information is not performed, the insurance-related operation ends.

In step ST2, the terminal device performs authentication processing. The information processing unit 22 of the terminal device 20 verifies whether the user who uses the terminal device is a user registered in advance by using the authentication unit 221, and proceeds to step ST3.

In step ST3, the terminal device performs authentication result informing processing. The information processing unit 22 of the terminal device 20 informs an authentication result of the authentication unit 221 to the sensing unit 21, and proceeds to step ST4.

In step ST4, the terminal device determines whether to be in an authenticated state. The information processing unit 22 of the terminal device 20 proceeds to step ST5 in a case of the authenticated state in which the user who uses the terminal device 20 is verified to be a user registered in advance, and ends the insurance-related operation in a case of not the authenticated state in which the user is not verified. Note that, when it is determined to be not the authenticated state, the process may return to step ST2 to perform the authentication processing.

In step ST5, the terminal device collects sensing information. In a case where an authentication result informed from the information processing unit 22 indicates that the user is verified, the sensing unit 21 of the terminal device 20 causes the data storage unit 226 of the information processing unit 22 to the hold sensing information collected by the sensing unit 21. Furthermore, the sensing information generated by the motion sensor unit 223 or the like of the information processing unit 22 is held in the data storage unit 226, and the process proceeds to step ST6.

In step ST6, the terminal device transmits the sensing information to the relay server. The information processing unit 22 of the terminal device 20 transmits the sensing information held in the data storage unit 226 to the relay server 30. Furthermore, the information processing unit 22 transmits the sensing information to the relay server 30 without including personal information of the user, and proceeds to step ST7. Note that the personal information is information to be used to identify the user, such as, for example, a name, an age, a gender, an address, an e-mail address, a telephone number, and an SNS account.

In step ST7, the terminal device determines whether the insurance proposal information has been transferred from the relay server. The information processing unit 22 of the terminal device 20 proceeds to step ST8 in a case where the information processing unit 22 has received the insurance proposal information from the relay server 30, and returns to step ST4 in a case where the information processing unit 22 has not received the insurance proposal information.

In step ST8, the terminal device performs insurance product contract processing. The information processing unit 22 of the terminal device 20 presents the received insurance proposal information to the user. The insurance proposal information includes information regarding an insurance product and information indicating a contract destination of the insurance product. When a user operation for making a contract of the insurance is performed, the information processing unit 22 performs communication of personal information and the like required for the contract of the insurance product between with the insurance business server 40 that is a contract destination of the desired insurance product without via the relay server 30, and the information processing unit 22 proceeds to step ST9.

In step ST9, the terminal device determines whether the contract is concluded. The information processing unit 22 of the terminal device proceeds to step ST10 in a case where the contract of the desired insurance product is concluded on the basis of the insurance proposal information, and ends the processing in a case where the contract is not concluded.

In step ST10, the terminal device adds the insurance business server as a provision destination of the sensing information. The information processing unit 22 of the terminal device 20 adds the insurance business server 40 that has made the contract for the proposed insurance product, as a provision destination of the sensing information. In this way, by adding the insurance business server 40 as a provision destination of the sensing information, the sensing information can be provided to the insurance business server 40 that has concluded the contract for the insurance product, without via the relay server 30. Furthermore, by providing the sensing information to the insurance business server 40 after conclusion of the contract, when follow-up information regarding the insurance product for which the contract is concluded is generated and transmitted by the insurance business server 40, the follow-up information is presented by the user interface unit 228. Moreover, by continuously providing the sensing information to the relay server 30, it is possible to receive insurance proposal information selected by another insurance company on the basis of the sensing information collected after conclusion of the contract.

Note that the flowchart illustrated in FIG. 3 is an example of the insurance-related operation of the terminal device, and may include processing not illustrated in FIG. 3. For example, when insurance renewal information is transmitted to the terminal device from the insurance business server 40 that has made a contract, the terminal device 20 may perform processing of presenting a content of the insurance renewal information to the user by using the user interface unit 228 of the information processing unit 22.

### <2-2. Operation of Relay Server>

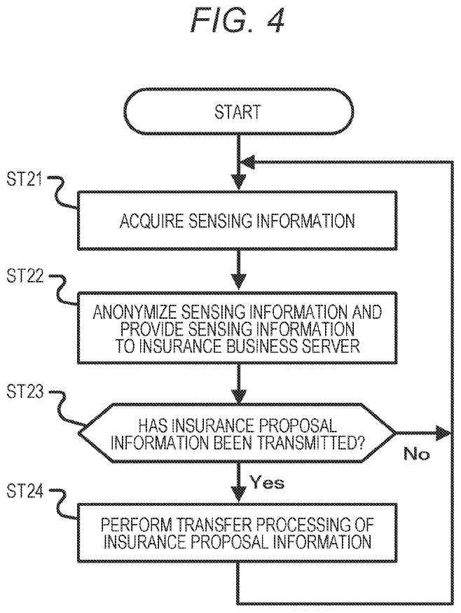

FIG. 4 is a flowchart illustrating an operation of the relay server. In step ST21, the relay server acquires sensing information. The relay control unit 31 of the relay server 30 acquires sensing information from the terminal device 20, and proceeds to step ST22. Note that the relay server 30 may store the acquired sensing information in the database unit 32 for every terminal device. As described above, by storing the sensing information in the database unit 32 for every terminal device, the sensing information can be provided to the insurance business server when the sensing information stored in the database unit 32 reaches the required period, for example, without accumulating, in the terminal device 20, sensing information for a period required for generating the insurance proposal information in the insurance business server 40 and then providing to the insurance business server via the relay server 30. Therefore, a data amount of the sensing information held by the terminal device 20 can be reduced.

In step ST22, the relay server anonymizes sensing information and provides the sensing information to the insurance business server. The relay control unit 31 of the relay server 30 anonymizes the sensing information acquired from the terminal device 20 and provides the sensing information to the insurance business server 40. Note that, in the anonymization, for example, identification information indicating a terminal device that has provided the sensing information is replaced with relay identification information. In this case, the relay control unit 31 stores the identification information and the relay identification information in association with each other in the database unit 32. Furthermore, the relay control unit 31 may read sensing information for a period required for generating the insurance proposal information in the insurance business server 40 from the database unit 32, anonymize the read sensing information, and provide the anonymized sensing information to the insurance business server.

In step ST23, the relay server determines whether the insurance proposal information has been transmitted. The relay server 30 proceeds to step ST24 in a case where the insurance proposal information is transmitted from the insurance business server 40 that has provided the anonymized sensing information, and returns to step ST21 in a case where the insurance proposal information has not been transmitted.

In step ST24, the relay server performs transfer processing of insurance proposal information. The relay control unit 31 of the relay server 30 transfers the insurance proposal information transmitted from the insurance business server 40, to the terminal device that is a providing source of the sensing information. For example, the relay control unit 31 returns the relay identification information used to transmit the insurance proposal information to the identification information, transfers the insurance proposal information transmitted from the insurance business server 40 to the terminal device of the identification information, and returns to step ST21.

Note that the flowchart illustrated in FIG. 4 is an example of the operation of the relay server, and may include processing not illustrated in FIG. 4.

### <2-3. Operation of Insurance Business Server>

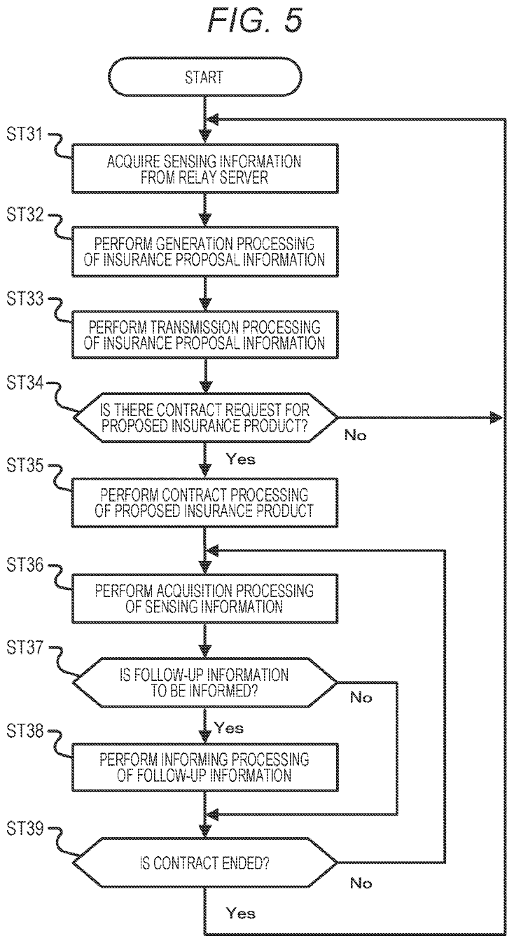

FIG. 5 is a flowchart illustrating an operation of the insurance business server. In step ST31, the insurance business server acquires sensing information from the relay server. The insurance business processing unit 41 of the insurance business server 40 acquires anonymized sensing information from the relay server 30, and proceeds to step ST32.

In step ST32, the insurance business server performs generation processing of insurance proposal information. The insurance business processing unit 41 of the insurance business server 40 selects an insurance product to be proposed on the basis of the sensing information, from insurance products stored in the insurance business database unit 42. Moreover, the insurance business processing unit 41 generates insurance proposal information indicating guidance of a proposed insurance product and a contact (for example, a URL, an e-mail address, or the like) for making a contract of the proposed insurance product, as the proposed insurance product for proposing the selected insurance product to the user, and proceeds to step ST33.

In step ST33, the insurance business server performs transmission processing of insurance proposal information. The insurance business processing unit 41 of the insurance business server 40 transmits the insurance proposal information generated in step ST32 to the relay server 30 by using the relay identification information of the anonymized sensing information, and proceeds to step ST34.

In step ST34, the insurance business server determines whether there is a contract request for the proposed insurance product. The insurance business processing unit 41 of the insurance business server 40 returns to step ST31 in a case where there is no contract request for the proposed insurance product indicated by the insurance proposal information transmitted in step ST33, and proceeds to step ST35 in a case where there is a contract request for the proposed insurance product.

In step ST35, the insurance business server performs contract processing of the proposed insurance product. The insurance business processing unit 41 of the insurance business server 40 communicates with the terminal device that has made the contract request for the proposed insurance product, without via the relay server 30. The insurance business processing unit 41 makes a request for personal information and the like required for an insurance contract to the user of the terminal device that has made the contract request, determines whether to conclude the contract after the required information is obtained from the user, and obtains approval of the insurance contract from the user in a case of concluding the contract. Moreover, the insurance business processing unit 41 stores personal information of the user who has concluded the insurance contract (hereinafter also referred to as an “insured person”), information regarding the contracted insurance product, and the like, in the insurance business database unit 42 in association with the sensing information, and the insurance business processing unit 41 proceeds to step ST36.

In step ST36, the insurance business server performs acquisition processing of sensing information. The insurance business processing unit 41 of the insurance business server 40 acquires the sensing information provided without via the relay server 30, from the terminal device 20 used by the insured person. Furthermore, the insurance business processing unit 41 associates the acquired sensing information with the personal information of the insured person, information regarding the contracted insurance product, and the like, and proceeds to step ST37.

In step ST37, the insurance business server determines whether to inform the follow-up information. The insurance business processing unit 41 of the insurance business server 40 performs risk discrimination of the user by using sensing information acquired after the conclusion of the insurance contract, or by using sensing information acquired after the conclusion of the insurance contract and sensing information acquired before the conclusion of the insurance contract. The insurance business processing unit 41 generates follow-up information indicating impartation of an incentive or the like, for example, in a case where a risk based on the sensing information is lower than a risk range assumed in the insurance product for which the insurance contract is concluded, and generates follow-up information indicating that a condition of insurance renewal is disadvantageous in a case where the risk is high. The insurance business processing unit 41 proceeds to step ST38 in a case where the follow-up information has been generated, and proceeds to step ST39 in a case where the follow-up information has not been generated.

In step ST38, the insurance business server performs informing processing of the follow-up information. The insurance business processing unit 41 of the insurance business server 40 informs the follow-up information to the terminal device 20 of the insured person, and proceeds to step ST39.

In step ST39, the insurance business server determines whether the contract is ended. In a case where a contract period of the proposed insurance product for which the contract is made in step ST35 expires or the contract is not renewed, or in a case where the contract is canceled, the insurance business processing unit 41 of the insurance business server 40 determines that the contract is ended and returns to step ST31, and returns to step ST36 in a case where the contract is continued.

Note that the flowchart illustrated in FIG. 5 illustrates a part of the operation of the insurance business server, and may include processing not illustrated in FIG. 5.

### <2-4. Operation Example of Insurance System>

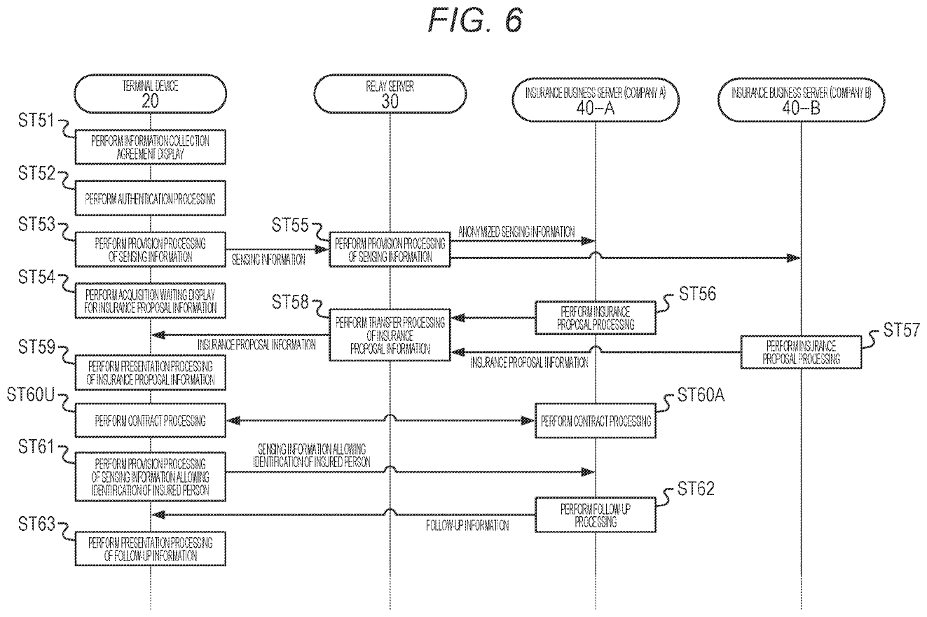

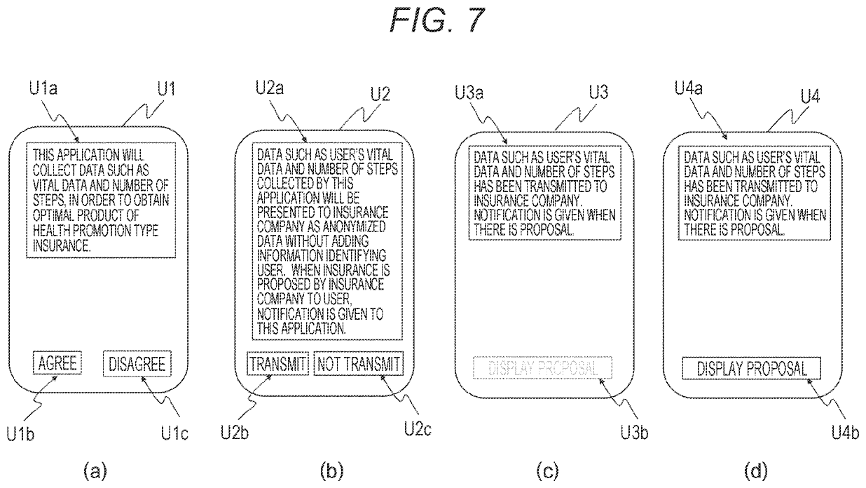

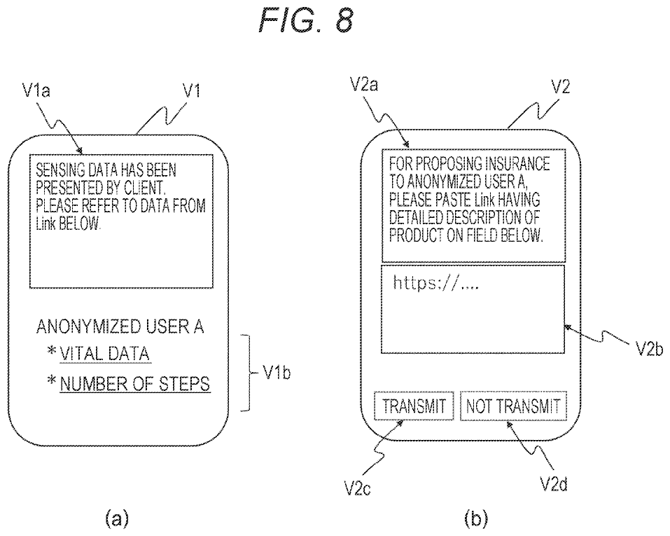

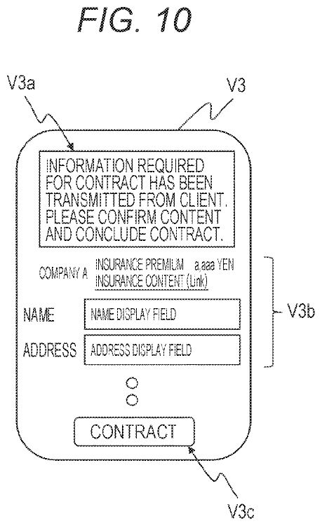

FIG. 6 is a sequence diagram illustrating an operation example of the insurance system. Furthermore, FIGS. 7, 9, and 11 illustrate operation display examples of the terminal device, and FIGS. 8 and 10 illustrate operation display examples of the insurance business server. Note that, FIG. 6 illustrates a case of providing sensing information to each of the insurance business servers 40-A and 40-B, generating insurance proposal information, and concluding a contract of an insurance product indicated by the insurance proposal information generated by the insurance business server 40-A.

In step ST51, the terminal device performs information collection agreement display. The information processing unit 22 of the terminal device 20 performs information collection agreement display on the user interface unit 228 to allow the user to agree to the collection of the sensing information. (a) of FIG. 7 illustrates a display screen U1 of the information collection agreement display. The display screen U1 is provided with display U1a indicating that sensing information is to be collected, a command button U1b to be operated in a case of agreeing to the collection, and a command button U1c to be operated in a case of disagreeing to the collection. When the command button U1b is operated, the information processing unit 22 permits the collection of the sensing information, and proceeds to step ST52. Furthermore, when the command button U1c is operated, the information processing unit 22 ends the operation.

In step ST52, the terminal device performs authentication processing. The information processing unit 22 of the terminal device 20 verifies whether the user who uses the terminal device is a user registered in advance, and performs the information provision agreement display on the user interface unit 228 in a case where the user is a registered user. (b) of FIG. 7 illustrates a display screen U2 of the information provision agreement display. The display screen U2 is provided with display U2a indicating that sensing information is anonymized to be provided, a command button U2b to be operated in a case of agreeing to provide the information, and a command button U2c to be operated in a case of disagreeing to provide the information. When the command button U2b is operated, the information processing unit 22 permits the provision of the sensing information, and proceeds to step ST53. Furthermore, in a case where the user is not a registered user or when the command button U2c is operated, the information processing unit 22 ends the operation.

In step ST53, the terminal device performs provision processing of sensing information. The information processing unit 22 of the terminal device 20 transmits the collected sensing information to the relay server 30 without including personal information of the user.

In step ST54, the terminal device performs acquisition waiting display for insurance proposal information. The information processing unit 22 of the terminal device 20 displays, on the user interface unit 228, the fact of being in an acquisition waiting state for insurance proposal information from an insurance company. (c) of FIG. 7 illustrates a display screen U3 indicating to be in the acquisition waiting state for the insurance proposal information. The display screen U3 is provided with display U3a indicating to be in the acquisition waiting state for the insurance proposal information. Furthermore, on the display screen U3, display U3b indicating acquisition of the insurance proposal information is illustrated as an inactive state (for example, grayout) in which selection (operation) is disabled.

In step ST55, the relay server performs provision processing of sensing information. The relay control unit 31 of the relay server 30 anonymizes sensing information acquired from the terminal device 20 and provides the sensing information to, for example, the insurance business server 40-A of a company A and the insurance business server 40-B of a company B.

In step ST56, the insurance business server of the company A performs insurance proposal processing. The insurance business server 40-A selects an insurance product to be proposed, on the basis of the anonymized sensing information provided from the relay server 30. Moreover, the insurance business server 40-A generates insurance proposal information regarding the proposed insurance product, and transmits the insurance proposal information to the relay server 30.

(a) of FIG. 8 illustrates a display screen V1 of sensing information, which is performed in the insurance business server 40-A. The display screen V1 of sensing information is provided with display V1a indicating that the sensing information has been provided, and link buttons V1b indicating items or the like of the sensing information that can be acquired. When any of the link buttons V1b is operated, the insurance business server 40-A switches to a display screen indicating the sensing information of the selected item. (b) of FIG. 8 illustrates a display screen V2 in a case of transmitting the insurance proposal information. The display screen V2 is provided with display V2a indicating that the insurance proposal information is to be transmitted, and display V2b indicating the insurance proposal information to be transmitted (for example, a link destination indicating a description, a contract destination, or the like of a proposed insurance product). Moreover, the display screen V2 is provided with a command button V2c to be operated in a case of agreeing to the transmission of the insurance proposal information, and a command button V2d to be operated in a case of disagreeing to the transmission. When the command button V2c is operated, the insurance business processing unit 41 of the insurance business server 40 transmits the insurance proposal information to the relay server 30. Furthermore, when the command button V2d is operated, the insurance business processing unit 41 ends the insurance proposal processing.

For example, the sensing information is assumed to include vital (pulse/heart rate) data, step number data, action data, and the like. The company A focuses on long-term continuation of daily gentle exercise, and sets a health promotion type insurance to be a,aaa yen per month, considering that an average walk count per day is large (additionally, pulse is moderately increased during walking) and this is continued for one month.

In step ST57, the insurance business server of the company B performs insurance proposal processing. Similarly to the insurance business server 40-A, the insurance business server 40-B selects an insurance product to be proposed, on the basis of the anonymized sensing information that has been provided. Moreover, the insurance business server 40-B generates insurance proposal information regarding the proposed insurance product, and transmits the insurance proposal information to the relay server 30.

For example, it is assumed that the sensing information further includes position information. Note that, an individual can be identified from the position information. Therefore, in a case where the position information is collected, a type of a facility identified by the position information is used as the sensing information, in the position information. The company B focuses on exercising with an appropriate load, and sets a health promotion type insurance to b,bbb yen per month, considering that action data indicates exercising at a fitness center on the weekend, for example, and the sensing information indicates exercising with a high load because the pulse rate at that point is high.

In step ST58, the relay server performs transfer processing of insurance proposal information. When the insurance proposal information is transmitted from the insurance business server in response to the provision of the anonymized sensing information, the relay server 30 transfers the transmitted insurance proposal information to a providing source of the sensing information.

In step ST59, the terminal device performs presentation processing of insurance proposal information. The information processing unit 22 of the terminal device acquires the insurance proposal information transmitted from the insurance business server 40 via the relay server 30, and presents the acquisition of the insurance proposal information to the user by using the user interface unit 228. (d) of FIG. 7 illustrates an acquisition informing display screen U4 of the insurance proposal information. The display screen U4 is provided with display U4a indicating being in acquisition waiting for the insurance proposal information, and display U4b indicating acquisition of the insurance proposal information. When the insurance proposal information is acquired, the display U4b is switched from an inactive state (a state in which selection (operation) cannot be performed) to an active state (a state in which selection (operation) can be performed).

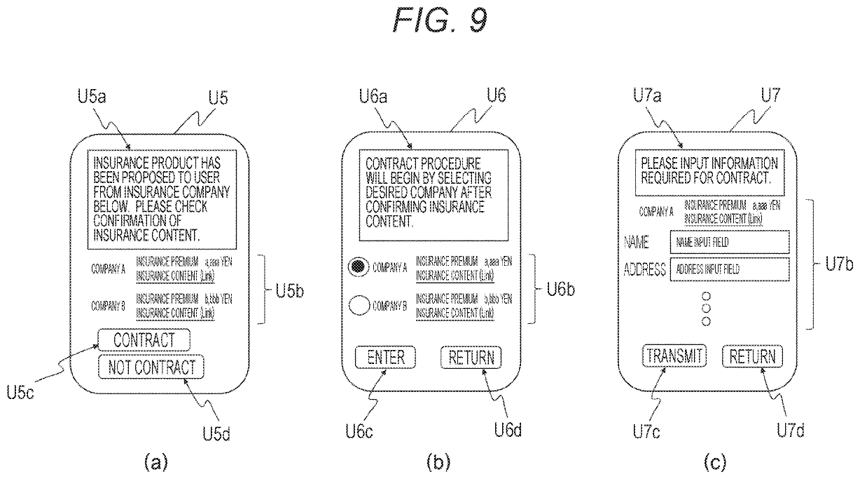

When a command button U4b is operated, the information processing unit 22 displays the acquired insurance proposal information on the user interface unit 228. (a) of FIG. 9 illustrates a display screen U5 of the insurance proposal information. The display screen U5 is provided with display U5a instructing confirmation of insurance contents, display U5b of insurance proposal information for each company, a command button U5c for a case of making a contract of the proposed insurance product, and a command button U5d for a case of not making a contract of the proposed insurance product.

In step ST60U, the terminal device performs contract processing. When the command button U5c of the presentation screen display U5 illustrated in (a) of FIG. 9 is operated, the terminal device 20 displays a contract screen. Furthermore, when the command button U5d is operated, the contract processing is not performed.

(b) of FIG. 9 illustrates a display screen U6 of a contract start. The display screen U6 is provided with display U6a indicating starting of an insurance contract, a radio button U6b indicating insurance proposal information for selection of a proposed insurance product, a command button U6c for a case of making a contract of the insurance product selected by the radio button, and a command button U6d for returning to the previous screen. When the command button U6c is operated after the insurance product is selected by the radio button, the terminal device 20 performs an insurance contract procedure.

(c) of FIG. 9 illustrates a display screen of the insurance contract procedure. A display screen U7 of the insurance contract procedure is provided with input instruction display U7a for personal information and the like required for an insurance contract, input field display U7b for information required for a contract of the selected insurance product, a command button U7c for transmission of the input personal information and the like to the insurance company, and a command button U7d for returning to the previous screen. The information processing unit 22 of the terminal device 20 receives an input of personal information and the like to the input field display U7b. Moreover, when the command button U7c is operated, the information processing unit 22 provides the input personal information and the like to the insurance business server of the insurance company selected by the radio button.

In step ST60A, the insurance business server performs contract processing. The insurance business server 40 performs a contract procedure by using information transmitted from the terminal device, by providing the insurance proposal information. FIG. 10 illustrates a display screen V3 of an insurance contract procedure performed for an administrator of the insurance business server 40.

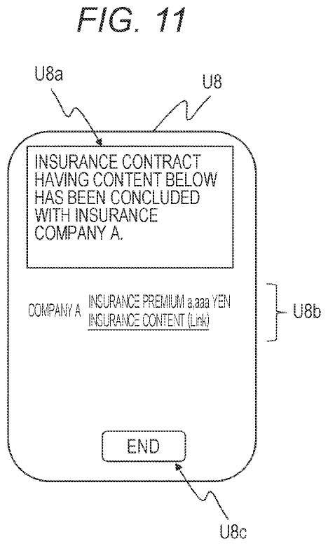

The display screen V3 of the insurance contract procedure is provided with confirmation instruction display V3a for personal information and the like required for the insurance contract, information display V3b indicating the insurance proposal information and the personal information and the like from the terminal device, and a command button V3c for establishing an insurance contract with the user of the terminal device. The insurance business processing unit 41 concludes the contract when information required for the insurance contract is provided, and the administrator of the insurance business server 40 operates the command button V3c, for example. Furthermore, when the contract is concluded, the insurance business processing unit 41 controls to store, in the insurance business database unit 42, personal information of the user (insured person) who has concluded the contract, an insurance product for which the contract has been concluded, sensing information provided from the terminal device of the insured person after the conclusion of the contract, the sensing information used to generate the insurance proposal information, and the like. Furthermore, the insurance business processing unit 41 informs completion of the contract conclusion to the terminal device that has transmitted the personal information and the like, and the terminal device 20 presents the informing of the completion of the contract conclusion to the insured person. FIG. 11 illustrates a display screen U8 indicating completion of the contract conclusion presented to the insured person.

The display screen U8 is provided with completion display U8a of the contract procedure, information display U8b of the insurance product for which the contract has been concluded, and a command button U8c for ending the procedure. When the command button U7c is operated, the information processing unit 22 of the terminal device ends the contract processing, and proceeds to step ST61.

Note that the terminal device may perform biometric authentication at the time of conclusion of the insurance contract, and may confirm that the user who provides the sensing information and the user who concludes the insurance contract are the same. Furthermore, the insurance contract procedure may be performed by exchanging a document between the user and the insurance company that has transmitted the insurance proposal information.

In step ST61, the terminal device performs provision processing of sensing information allowing identification of the insured person. The information processing unit 22 of the terminal device 20 clarifies which insured person the collected sensing information belongs, and provides the sensing information allowing identification of the insured person to the insurance business server of the insurance company that has concluded the insurance contract, without via the relay server 30.

In step ST62, the insurance business server performs follow-up processing. The insurance business server 40-A generates follow-up information on the basis of the sensing information provided from the terminal device 20 of the insured person, and informs the follow-up information to the terminal device 20.

For example, in a case where an activity amount of the user is reduced as compared with that at the time of conclusion of the contract, and the risk becomes higher than the risk range at the time of conclusion of the contract, the insurance business server 40-A generates follow-up information indicating that insurance renewal is disadvantageous, for example, an increase in insurance premium or inability to renew at the time of renewal of the insurance contract. Furthermore, for example, in a case where the activity amount of the user is increased as compared with that at the time of conclusion of the contract, and the risk becomes lower than the risk range at the time of conclusion of the contract, the insurance business processing unit 41 generates follow-up information indicating impartation of an incentive, for example, discount of the insurance premium or impartation of points that can be used for purchase of various products. Note that the informing of the follow-up information may be performed every time a predetermined period elapses from the time of conclusion of the contract. In this case, for example, when the activity amount of the user is equal to that at the time of conclusion of the contract and the risk is within the range at the time of conclusion of the contract, the fact may be informed by the follow-up information.

For example, in a case where the health promotion type insurance with which the contract is concluded is aaaa yen per month, provision of the sensing information is continuously performed, an average walk count per day is high (additionally, pulse is moderately increased during walking), and this is continued for three months, the fact that the health promotion type insurance becomes (aaaa−cccc) yen per month is informed by the follow-up information.

In step ST63, the terminal device performs presentation processing of the follow-up information. The information processing unit 22 of the terminal device 20 acquires follow-up information transmitted from the insurance business server 40-A, and presents the follow-up information to the insured person from the user interface unit 228.

Note that the flowcharts of FIGS. 3 to 5 and the sequence diagram of FIG. 6 are examples, and may include processing not illustrated in the figures. Furthermore, the display of the user interface unit 228 is not limited to the operation display examples of FIGS. 7 to 11, and may be other display, and a part of the display may be omitted or display not illustrated may be performed, as long as the user can grasp the transmitted information and the like. For example, the display of (c) of FIG. 7 may be omitted, and the display illustrated in (d) of FIG. 7 may be performed when the insurance proposal information is acquired.

As described above, according to the insurance system of the invention of the present application, it becomes possible to easily receive a proposal for an insurance product optimal for the user's activity or the like from one or plurality of insurance companies, without providing the user's personal information or the like. Therefore, the user can select and contract the optimal insurance product without taking effort and time. Furthermore, the insurance company can personalize insurance products having the same condition so far in accordance with the user, and can provide a more detailed product.

Furthermore, when the insurance contract is concluded, personal information or the like of the insured person is provided from the terminal device to the insurance business server, so that the insurance business server can reliably acquire information required for the insurance contract. Moreover, after conclusion of the insurance contract, the sensing information collected by the terminal device is provided without being anonymized to the insurance business server that has concluded the contract, so that the follow-up information according to activity or the like of the insured person can be presented from the insurance business server to the insured person.

### <2-5. Other Operations of the Insurance System>

Meanwhile, as the sensing information to be used for selection of a proposed insurance product, different information may be used for each insurance business server. In this case, required sensing information is registered in advance in the relay server, and sensing information acquired from the terminal device is selected and transmitted to the insurance business server, whereby the sensing information can be efficiently relayed.

Furthermore, the above-described embodiment has exemplified the insurance system that proposes a health promotion type insurance optimal for physical activity of the user, but the insurance system is not limited to the case of proposing the health promotion type insurance. For example, the insurance system can also propose a sports insurance, a leisure insurance, and the like, by collecting, with the terminal device, sensing information indicating physical activity information, a type of a facility being used, and the like, and providing the sensing information to the insurance business server via the relay server. Furthermore, the insurance system can also propose an automobile insurance, a motorcycle insurance, and the like, by collecting information indicating a driving operation of the user or a behavior of a vehicle according to the driving operation as sensing information, and providing the sensing information to the insurance business server via the relay server.

A series of processing described in the specification may be executed by hardware, software, or a composite configuration of both. In a case of executing the processing by the software, a program recorded with a processing sequence is installed and executed in a memory incorporated in dedicated hardware in a computer. Alternatively, the program can be installed and executed on a general-purpose computer capable of executing various processing.

For example, the program can be recorded in advance in a hard disk, a solid state drive (SSD), or a read only memory (ROM) as a recording medium. Alternatively, the program may be temporarily or permanently stored (recorded) in a removable recording medium such as a flexible disk, a compact disc read only memory (CD-ROM), a magneto optical (MO) disk, a digital versatile disc (DVD), a Blu-ray disc (BD) (registered trademark), a magnetic disk, a semiconductor memory, and the like. Such a removable recording medium can be provided as what is called package software.

Furthermore, in addition to being installed on the computer from the removable recording medium, the program may be transferred to the computer in a wired or wireless manner from a download site via a network such as a wide area network (WAN) represented by cellular, a local area network (LAN), the Internet, and the like. In the computer, it is possible to receive the program transferred in this manner and to install the same on a recording medium such as a built-in hard disk and the like.

Note that the effects described in this specification are merely examples and are not limited, and additional effects that are not described may be present. Furthermore, the present technology should not be construed as being limited to the above-described embodiment. The embodiment of this technology discloses the present technology in the form of illustration, and it is obvious that those skilled in the art may modify or replace the embodiment without departing from the gist of the present technology. That is, in order to determine the gist of the present technology, claims should be taken into consideration.

Furthermore, the terminal device of the present technology may also have the following configurations.

(1) A terminal device including:
a communication unit configured to communicate with a relay server and an insurance business server, the relay server being configured to anonymize sensing information to be used for selection of an insurance product and provide the sensing information to the insurance business server, and the insurance business server being configured to transmit insurance proposal information indicating an insurance product selected on the basis of the anonymized sensing information;
a user interface unit configured to present, to a user, the insurance proposal information informed from the insurance business server via the relay server; and
a control unit configured to control operations of the communication unit and the user interface unit.

(2) The terminal device according to (1), in which the control unit controls the communication unit to communicate with the insurance business server without via the relay server, in response to a user operation on the insurance proposal information presented by the user interface unit.

(3) The terminal device according to (2), in which after conclusion of a contract of an insurance product proposed by the insurance proposal information, the control unit provides the sensing information to the insurance business server without via the relay server.

(4) The terminal device according to (3), in which the control unit presents, on the user interface unit, follow-up information regarding an insurance product for which the contract is concluded, the follow-up information being provided from the insurance business server after conclusion of the contract.

(5) The terminal device according to any one of (1) to (4), in which the control unit transmits the sensing information of a user verified by user authentication processing, to the relay server.

(6) The terminal device according to any one of (1) to (4), in which the control unit transmits the sensing information to the relay server without including personal information of the user.

(7) The terminal device according to any one of (1) to (6), further including:
an information collection unit configured to collect the sensing information, in which
the information collection unit acquires information regarding physical activity of the user as the sensing information.

(8) The terminal device according to (7), in which, in a case where position information is collected by the information collection unit, the control unit uses a type of a facility identified by the position information as the sensing information.

Furthermore, the present technology can include the following insurance system.

An insurance system including:
a terminal device configured to collect sensing information to be used for selection of an insurance product;
an insurance business server configured to generate insurance proposal information on the basis of sensing information; and
a relay server configured to relay information communication between the terminal device and the insurance business server, in which
the terminal device includes:
a communication unit configured to perform communication between with the relay server and the insurance business server;
a user interface unit configured to present, to a user, the insurance proposal information informed from the insurance business server via the relay server; and
a control unit configured to control operations of the communication unit and the user interface unit,
the relay server includes:
a relay control unit configured to anonymize sensing information supplied from the terminal device, provide the sensing information to the insurance business server, and transfer insurance proposal information informed from the insurance business server to a terminal device that is a providing source of the sensing information, in response to provision of the anonymized sensing information to the insurance business server, and
the insurance business server includes:
an insurance business processing unit configured to perform processing of generating insurance proposal information on the basis of sensing information supplied from the relay server, and transmitting the insurance proposal information to the relay server, the insurance business processing unit being configured to perform insurance conclusion processing between with a terminal device in which a contract request is made on the basis of the insurance proposal information.

### REFERENCE SIGNS LIST

10 Insurance system
20, 20-1, 20-2 Terminal device
21 Sensing unit
22 Information processing unit
30 Relay server
31 Relay control unit
32 Database unit
40, 40-A, 40-B Insurance business server
41 Insurance business processing unit
42 Insurance business database unit
50 Network
211 Vital measurement unit
212 Step number measurement unit
213 Action measurement unit
214, 222 Positioning unit
218, 226 Data storage unit
219 Proximity communication processing unit
221 Authentication unit
223 Motion sensor unit
225 Proximity communication unit
227 Communication unit
228 User interface unit
229 Control unit

1. A terminal device comprising:
a communication unit configured to communicate with a relay server and an insurance business server, the relay server being configured to anonymize sensing information to be used for selection of an insurance product and provide the sensing information to the insurance business server, and the insurance business server being configured to transmit insurance proposal information indicating an insurance product selected on a basis of the anonymized sensing information;
a user interface unit configured to present, to a user, the insurance proposal information informed from the insurance business server via the relay server; and
a control unit configured to control operations of the communication unit and the user interface unit.

2. The terminal device according to claim 1, wherein
the control unit controls the communication unit to communicate with the insurance business server without via the relay server, in response to a user operation on the insurance proposal information presented by the user interface unit.

3. The terminal device according to claim 2, wherein
after conclusion of a contract of an insurance product proposed by the insurance proposal information, the control unit provides the sensing information to the insurance business server without via the relay server.

4. The terminal device according to claim 3, wherein
the control unit presents, on the user interface unit, follow-up information regarding an insurance product for which the contract is concluded, the follow-up information being provided from the insurance business server after conclusion of the contract.

5. The terminal device according to claim 1, wherein
the control unit transmits the sensing information of a user verified by user authentication processing, to the relay server.

6. The terminal device according to claim 1, wherein
the control unit transmits the sensing information to the relay server without including personal information of the user.

7. The terminal device according to claim 1, further comprising:
an information collection unit configured to collect the sensing information, wherein
the information collection unit acquires information regarding physical activity of the user as the sensing information.

8. The terminal device according to claim 7, wherein
in a case where position information is collected by the information collection unit, the control unit uses a type of a facility identified by the position information as the sensing information.

9. The terminal device according to claim 1, wherein
the control unit transmits the sensing information to the relay server when the sensing information for a predetermined period is collected.

10. An information processing method comprising:
communicating with a relay server and an insurance business server by using a communication unit, the relay server being configured to anonymize sensing information to be used for selection of an insurance product and transfer the sensing information to the insurance business server, and the insurance business server being configured to transmit insurance proposal information indicating an insurance product selected on a basis of the anonymized sensing information;
informing, to a user, the insurance proposal information informed from the insurance business server via the relay server, by using a user interface unit; and
controlling operations of the communication unit and the user interface unit by using a control unit.

11. A program for causing a computer to execute purchase of an insurance product,
the program causing the computer to execute:
a procedure of transmitting sensing information to a relay server configured to anonymize the sensing information to be used for selection of the insurance product and transfer the sensing information to an insurance business server;
a procedure of acquiring insurance proposal information transmitted via the relay server from the insurance business server configured to transmit the insurance proposal information indicating an insurance product selected on a basis of the anonymized sensing information;
a procedure of informing, to a user, the insurance proposal information informed from the insurance business server via the relay server, by using a user interface unit; and
a procedure of performing an insurance contract between with the insurance business server in response to a user operation, on a basis of the insurance proposal information.

12. A relay server comprising:
a relay control unit configured to anonymize sensing information supplied from a terminal device that collects sensing information to be used for selection of an insurance product, provide the sensing information to one or plurality of insurance business servers, and transfer insurance proposal information informed from the one or plurality of insurance business servers to a terminal device that is a providing source of the sensing information, in response to provision of the anonymized sensing information to the one or plurality of insurance business servers.

13. The relay server according to claim 12, wherein
in the anonymization, the relay control unit replaces identification information indicating a terminal device that has collected the sensing information with relay identification information.

14. The relay server according to claim 13, wherein
the relay control unit returns the relay identification information used for informing the insurance proposal information to the identification information, and transfers the insurance proposal information to a terminal device that is a providing source of the sensing information.

15. The relay server according to claim 12, wherein
for each insurance business server, sensing information to be used for selection of the insurance product is selected from the supplied sensing information, and provided.

16. An insurance business server comprising:
an insurance business processing unit configured to perform processing of generating insurance proposal information on a basis of sensing information provided from a relay server, and transmitting the insurance proposal information to the relay server, the relay server being configured to anonymize sensing information to be used for selection of an insurance product, and the insurance business processing unit being configured to perform insurance conclusion processing between with a terminal device in which a contract request is made on a basis of the insurance proposal information.

17. The insurance business server according to claim 16, wherein
the insurance business processing unit selects a proposed insurance product on a basis of the sensing information, and generates the insurance proposal information indicating the proposed insurance product and an insurance contract destination.

18. The insurance business server according to claim 16, wherein
the insurance business processing unit generates follow-up information regarding an insurance product for which an insurance contract has been concluded on a basis of sensing information supplied from a terminal device of a user who has concluded an insurance contract on a basis of the insurance proposal information, and the insurance business processing unit transmits the follow-up information to the terminal device of the user who has concluded the insurance contract.

19. The insurance business server according to claim 18, wherein
the insurance business processing unit generates follow-up information indicating impartation of an incentive in a case where a risk based on the sensing information is lower than a risk range assumed in an insurance product for which an insurance contract is concluded, and the insurance business processing unit generates follow-up information indicating that a condition of insurance renewal is disadvantageous in a case where a risk is high.
